(19) United States
(12) Patent Application Publication
(10) Pub. No.: US 2021/0158324 A1
(43) Pub. Date: May 27, 2021

(54) Mobile Order Processing

(71) Applicant: NCR Corporation, Atlanta, GA (US)

(72) Inventors: Michael Robert Dunn, Tucker, GA (US); Nathalie Chikhi, Apopka, FL (US)

(21) Appl. No.: 16/694,648

(22) Filed: Nov. 25, 2019

(51) Int. Cl. G06Q 20/32; G06Q 30/06; G06Q 20/20; G06Q 20/10; G06Q 20/40; G06Q 20/12

(52) U.S. Cl. CPC G06Q 20/32; G06Q 30/0635; G06Q 20/12; G06Q 20/10; G06Q 20/40; G06Q 20/20

(57) ABSTRACT

Upon initiate of a mobile application on a mobile, the mobile application identifies an establishment where the mobile device is located. The mobile application presents a menu for the establishment and a user selects an item to order from the menu within the application. A tab is opened, and order details associated with the order are sent to a fulfillment terminal within the establishment. The order is fulfilled and delivered to a pick-up location within the establishment. The tab is closed automatically or through user-selection within the mobile application, and payment details associated with the user is transferred to the fulfillment terminal for payment of the tab.

### BACKGROUND

When an establishment becomes overcrowded, it is hard for consumers to get service while competing with other patrons that are vying for the attention of staff of the establishment. This limits the amount of revenue that the establishment can take in, creating a bottleneck with the staff, and also makes some patrons/customers less like to return due to the appearance of poor service.

This is particularly problematic in bars, where there are limited servers and patrons usually compete for the attention of one or two bartenders. It often appears as if the bartender has no procedure by which he/she waits on the patrons and often it appears that the bartender waits on the first patron that he/she makes eye contact with even when other patrons have been waiting at the bar for much longer periods of time then the patron that gets waited on. In some instances, patrons can get frustrated and shout at the bartender or other patrons that they think came to the bar after them and were waiting on by the bartender.

This can make for a tense environment where even patrons not waiting on service are reluctant to return to the bar. This situation may also force management of the bar to request some patrons causing the commotion to leave the bar, which almost assures that the expelled patrons will never return to the bar with subsequent business.

It is also problematic that the bartender has to: maintain multiple open tabs for patrons that want open tabs, handle money and/or credit cards for each order and operate the terminal while the bartender is attempting to fulfill orders in order to record orders and collect payment for the orders. All these necessary tasks slow down patron order fulfillment, which exacerbates the patron queues at the bar awaiting an opportunity to place an order with the bartender.

In fact, the bartender is often in a no-win situation, where he/she will inevitably fail to provide adequate service to at least one of their patrons. This also means less tips and lower-value tips for the bartender, less sales for the bar, and less repeating or returning patrons to the bar.

### SUMMARY

In various embodiments, methods and a system for mobile order processing are presented.

According to an embodiment, a method for mobile order processing is presented. Specifically, and in one embodiment, an identifier and a device location is received from a mobile application executing on a device operated by a user. The identifier is associated with a registered account. A reference link to a menu of an establishment associated with the device location is passed to the mobile application. An item selection for an item from the menu is obtained from the mobile application. A tab is opened for the item, and the item selection and payment details associated with the account are forwarded to a terminal associated with the establishment.

### BRIEF DESCRIPTION OF THE DRAWINGS

FIG. 1A is a diagram of a system for providing mobile order processing, according to an example embodiment.

FIG. 1B is a diagram of a mobile device implemented method for providing mobile order processing, according to an example embodiment.

FIG. 2 is a diagram of a method for mobile order processing, according to an example embodiment,

FIG. 3 is a diagram of another method for mobile order processing, according to an example embodiment.

FIG. 4 is a diagram of another system for mobile order processing, according to an example embodiment.

### DETAILED DESCRIPTION

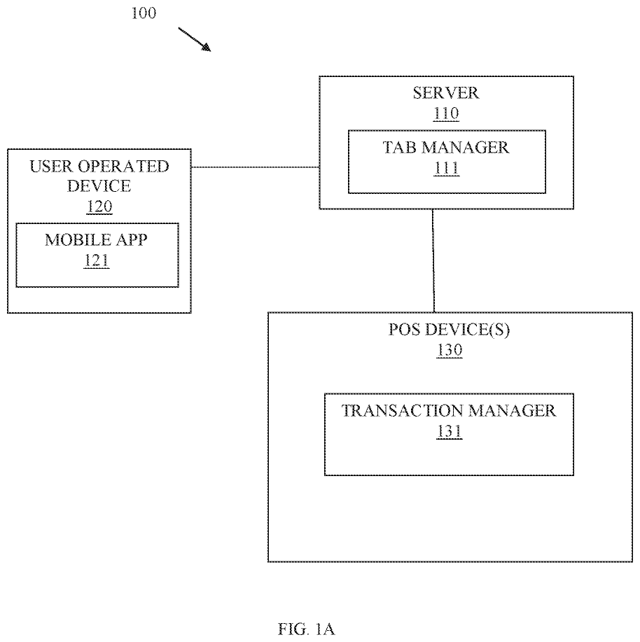

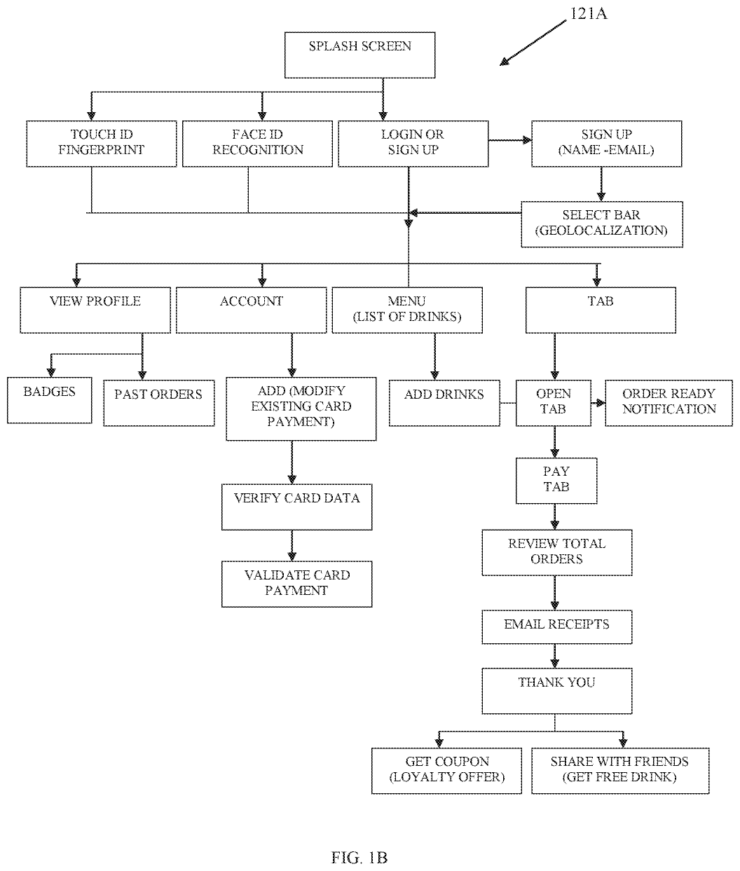

FIG. 1A is a diagram of a system for mobile order processing, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the mobile order processing techniques presented herein and below.

Moreover, various components are illustrated as one or more software modules, which reside in non-transitory storage and/or hardware memory as executable instructions that when executed by one or more hardware processors perform the processing discussed herein and below.

The techniques, methods, and systems presented herein and below for mobile order processing can be implemented in all, or some combination of the components shown in different hardware computing devices having one or more hardware processors.

The system 100 includes: a server 110, a user-operated mobile device 120, and one or more Point-Of-Sale (POS) devices/terminals 130. Each device 110-130 include their own hardware processors and non-transitory computer-readable storage media having executable instructions representing a tab manager 111 for server 110, a mobile application (app) for user-operated device 120, and a transaction manager 130 for POS device 130. The executable instructions when executed by the corresponding processors from the corresponding non-transitory computer-readable storage medium performs the processing discussed herein and below with respect to tab manager 111, mobile app 121, and transaction manager 131.

As used herein the terms: “consumer,” “customer,” “patron,” or “user” can be used interchangeably and synonymously. These terms refer to an individual that operates mobile device 120, places an order, opens a tab, and pays for any order items or tab items within an establishment.

Mobile app 121 provides a user-facing interface to a user operating device 120. A more detailed processing flow for mobile app 121 is discussed below with the discussion of the FIG. 1B. Moreover, mobile app 121 may be processed with multiple different establishments and different types of establishments that have different POS devices 130.

The system 100 provides techniques by which users/patrons can initiate a tab or place an order from mobile app 121, the order is received by tab manager 111 of server 110 and communicated to transaction manager 131 of POS device 130. The placement of the order, payment of the order, and maintenance of any tab may be handled by tab manager 111 on behalf of transaction manager 131 or may be handled directly by transaction manager 131 as relayed by tab manager 111 from mobile app 121. Once an order is placed, an order number of tab number is created with transaction manager 131, the items of the order and order details may be communicated by transaction manager 131 to any kitchen device or terminal/display device that may be required to fulfill the items of the order or may be communicated on a display screen of POS device 130 by transaction manager 131 (or both). Orders received are listed to the kitchen (fulfillment area device) and/or POS device 130 in a queue based on when received from or when placed by the patrons. The individual or staff fulfilling the order located in a same area of the POS device 130 (in the case of a bar drink being ordered as the item) or the fulfillment device (in case of a food item being ordered as the item), views the queue and fulfills the order from the queue. The ordered items are then placed in an area (such as on the bar), where the ordering patron self-picks up the items.

The staff of the establishment focuses on fulfilling orders, patrons are not competing with other patrons to place orders, and the staff does not have to operate POS device 130 to enter orders for patrons and to collect payments for orders and/or obtain and process credit cards for opening and closing tabs of patrons.

FIG. 1B illustrates a method 121A processed by mobile app 121. Initially, a patron downloads and installs mobile app 121. When the mobile app 121 is first accessed or initiated from device 120, a splash screen is presented on the display of device 120 through a user-facing interface of app 121, and the patron is asked to login or to sign-up if the patron has not signed up for mobile app order services provided by system 100. A new user supplies a name and an email address for signing up and asked through the user facing interface to provide login credentials, which can be through touch id of a fingerprint, face identification through facial recognition, or email address and password credential. An account is created and the user-facing interface requests that the user add a card payment now or later when needed. This can be automated by allowing the patron to use a camera integrated into device 120 to snap an image of a payment card.

The patron may also request that the patron enable location tracking through a select bar in the user-facing interface, which allows app 121 to uses location services of device 120 to determine a geographical location of the patron when the app 121 is initiated on device 120 by the patron.

Once signed up with an account and any initial registered payment card, the app 121 upon detecting that the patron has activated the app 121 and is signed in, obtains a location of device 120 from location services and identifies an establishment that the device 120 is determined to be present at. A menu associated with the establishment is presented in the user-facing interface, which may include a list of drinks for the establishment along with any available food items.

The user-facing interface receives selections for drinks or orders of any food items from the menu and a tab is opened based on the registered payment card or a different payment card being used for just this visit by the user (the add option includes a modify existing card payment sub-option).

The user-facing interface also permits options to view the patron profile that includes any badges award from usage of app 121 and past orders placed by the patron. The account option allows payment cards to be removed, added, or modified.

When the patron is ready, payment is made through the pay tab option. Patron can review the order details associated with the tab and order total price, have a receipt for the order emailed to the patron, etc.

The user-facing interface sends a in-app notification to the patron when the transaction manager 131 reports to transaction manager 111 that the order has been fulfilled. Patron then proceeds to a pick-up area, such as the bar and retrieves what was ordered.

Upon payment for the tab, a variety of additional options may be presented through the user-facing interface, such as coupons or a loyalty account offer. For example, allowing tab manager 111 to post to friends of patron on social media or through text messaging the order at the establishment processed on behalf of the patron; permitting such an action may allow patron to receive a free drink or appetizer on a next visit to the establishment or a next visit to any establishment that supports system 100.

The app 121 interacts with tab manager 111 of server 110. Tab manager 111 maintains patron account information and interacts with both app 111 and transaction manager 131. When app 121 reports a patron is attempting to sign in to app 121, tab manager 111 authenticates the user and retrieves patron account details. Tab manager 111 also receives location information from location services of device 120 through app 121. The geolocation of device 120 is matched to an establishment identifier. The establishment identifier is linked to a menu that is specific to an establishment associated with the establishment identifier. When the app 121 reports a selection for a menu item to tab manager 111, an order identifier is opened associated with an open tab. The selection details for ordered items and registered payment card details are transmitted from tab manager 111 to transaction manager 131 for order fulfillment.

Transaction manager 131 receives the order details and payment details and forwards the order details to a fulfillment device, which may be POS device 130 and/or a kitchen-based device where food is fulfilled. Staff receives the order details on a display screen and prepares the ordered items associated with the order details. When the ordered items are prepared for the order details, the staff selects indicating the order was fulfilled in a transaction interface for transaction manager 131 and delivers the ordered items to a pickup location. Transaction manager 131 communicates an order completion notification to tab manager 111. Tab manager 111 sends an in-app message to app 121. App 121 displays a push notification message on the display of device 120; the push notification message may also indicate where the ordered items are to be picked up within the establishment by the patron. The patron picks up the ordered items at the pickup location (which may be a bar within the establishment).

Staff of the establishment only has to read the order details from the queue on a display device, prepare the ordered items that correspond to the order details, and touch an order completion option in the transaction interface of transaction manager 131. There is no need to interact with patrons, determine an order of patrons for serving, enter order details for patron orders, collect payment card information for tabs, collect payment for orders, and/or remember faces of patrons to associate them with the appropriate open tabs.

A number of variations on the above-noted processing can be achieved.

For example, the app 121 may present multiple options for different establishments for selection by the patron to reduce geolocation error when multiple establishments are physically close to one another.

App 121 may allow a patron to search and select a specific establishment when patron's do not wish to enable and allow location-based services for app 121.

The order number or tab number for an open tab may be assigned by transaction manager 131. The order number or tab number may be maintained independently by tab manager 111 and a different order number or tab number supplied for an order by transaction manager 131, where tab manager 111 maintains a mapping between its assigned order/tab number and the transaction-manager assigned order/tab number. This latter embodiment permits each establishment to maintain its own independent transaction numbers/order numbers, while independently allowing tab manager 111 to maintain its own records for patron-based activity across multiple different establishments and types of establishments.

An open tab associated with multiple orders of a patron may be closed at any time by the patron within app 121 by selecting the pay tab option. Any open tab may be automatically closed by tab manager 111 when transaction manager 131 indicates that ordering has stopped with the establishment.

App 121 may present additional messages/notifications indicating that the establishment is accepting last calls or orders before closing, allowing patron to make one last order before the patron tab is automatically closed using registered payment card details of the patron.

Tab manager 111 may processing payment details for a closed tab on behalf of transaction manager 131 or transaction manager 131 performs payment processing using payment details provided by tab manager 111.

Tab manager 111 may push order details for an order to multiple establishment devices, such as a bar-based POS device 130 and a kitchen-based fulfillment device when the order details indicate a drink and a food order. Alternatively, transaction manager 131 pushes the kitchen-based fulfillment notification to the fulfillment device of the kitchen and to a bar fulfillment device once provided the order details from tab manager 111.

In an embodiment, server 110 is a cloud-based server associated with a plurality of servers logically cooperating as a single server and providing the tab manager 111 as a service to both patrons and establishments.

In an embodiment, server 110 provides tab manager services to a single establishment on behalf of that establishment's customers/patrons.

In an embodiment, tab manager 111 is provided as a subscription service to a variety of establishments based on set fees. In an embodiment, tab manager 111 collects transactional-based fees for each order or tab that is closed from the establishments.

In an embodiment, app 121 includes an automated chat bot as an additional user interface to app 121. The automated chat bot allows the patron to engage in a natural-language voice dialogue to place orders, close a tab, change payment methods, and review account details, badges, and/or past orders. Voice received instructions from the patron and translated into text and communicated through an Application Programming Interface (API) to transaction manager 131. Order fulfillment notifications received from transaction manager 131 through API are then translated from text to natural language voice communicated through a speaker of device 120 to the patron.

In an embodiment, app 121 includes both a user-facing Graphical User Interface (GUI) as described above with the discussion of FIG. 1B and also includes a chat bot interface, bother interfaces are synchronized with one another during any user interaction.

In an embodiment, user-operated device 120 is a mobile device. The mobile device is a phone, a laptop, or a wearable processing device.

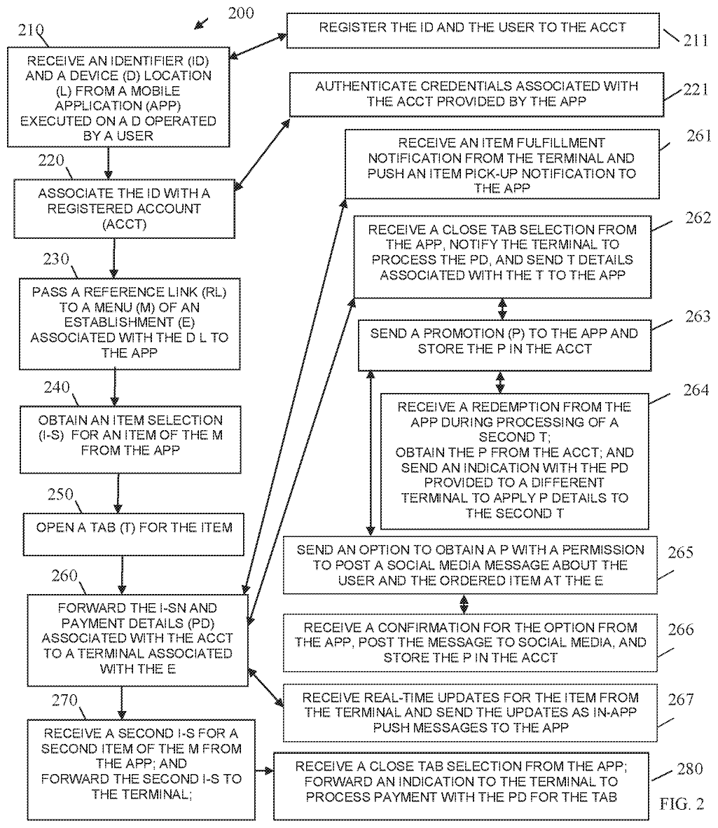

These and other embodiments are now discussed with reference to the FIGS. 2-4,

FIG. 2 is a diagram of a method 200 for mobile order processing, according to an example embodiment. The software module(s) that implements the method 200 is referred to as a “tab manager.” The tab manager is implemented as executable instructions programmed and residing within memory and/or a non-transitory computer-readable (processor-readable) storage medium and executed by one or more hardware processors of a hardware computing device. The processors of the device that executes the tab manager are specifically configured and programmed to process the tab manager. The tab manager has access to one or more networks during its processing. The networks can be wired, wireless, or a combination of wired and wireless.

In an embodiment, the device that executes the tab manager is server 110.

In an embodiment, the device that executes the tab manager is a cloud processing environment comprising multiple servers that logically cooperate as a single server.

In an embodiment, the tab manager is tab manager 111.

At 210, the tab manager receives an identifier and a device location from a mobile application that executes on a mobile device operated by a user. In an embodiment, the mobile application is mobile application 121. The identifier can be a device identifier, or a user identifier registered to the user (assuming the user is already registered with the tab manager).

In an embodiment, at 211, the tab manager registers the identifier and the user to an account as a registered account. This would be a first time the user is accessing tab manager for mobile ordering services.

At 220, the tab manager associates the identifier with a registered account, which is maintained and managed by the tab manager.

In an embodiment, at 221, the tab manager authenticates credentials associated with the registered account provided by the mobile application (app).

At 230, the tab manager passes a reference link to a menu of an establishment associated with the mobile device location to the app.

At 240, the tab manager obtains an item selection for an item of the menu from the app based on user interaction with a user-facing interface of the app and presentation of the menu within the user-facing interface by the app.

At 250, the tab manager opens a tab for the item based on the item selection received at 240.

At 260, tab manager forwards the item selection and payment details associated with the registered account to a terminal associated with the establishment. In an embodiment, the terminal is POS terminal 130. In an embodiment, the terminal is any fulfillment terminal located at the establishment.

In an embodiment, at 261, the tab manager receives an item fulfillment notification from the terminal and pushes an item pick-up notification to the app. The item pick-up notification informs the user of the mobile app that the item ordered is ready for pick-up within the establishment and optionally a pick-up location for the user to obtain the item within the establishment.

In an embodiment, at 262, the tab manager receives a close tab selection from the app. The tab manager notifies the terminal to process the payment details, and the tab manager sends tab details for the ordered item, price of item, and any other items ordered for the tab and their prices, along with a total price for the tab to the app.

In an embodiment of 262 and at 263, the tab manager sends a promotion to the app and stores the promotion or a reference to the promotion in the registered account of the user.

In an embodiment of 263 and at 264, the tab manager receives a redemption request from the app during processing of a second tab associated with a second establishment where the user is located. The tab manager obtains the promotion or promotion reference from the user's registered account, and the tab manager sends an indication with the promotion details provided to a different terminal associated with the second establishment. The tab manager instructs the different terminal to apply the promotion details to the second tab when processing the payment details and obtaining payment for the second tab.

In an embodiment of 263 and at 265, the tab manager sends an option to obtain a promotion with a condition that a permission to post a social media message to a social media account about the user and the ordered item at the establishment.

In an embodiment of 265 and at 266, the tab manager receives a confirmation from the option from the app, posts the message to the social media account, and stores the promotion or a reference to the promotion in the registered user account.

In an embodiment, at 267, the tab manager receives real-time updated for fulfillment and order processing with respect to the item from the terminal and sends those updates as in-app push messages to the app.

In an embodiment, at 270, the tab manager receives a second item-selection for a second item of the menu from the app. The tab manager forwards the second item selection to the terminal.

In an embodiment of 270 and at 280, the tab manager receives a close tab selection from the app. The tab manager forwards an indication to the terminal to process payment with the payment details for the tab,

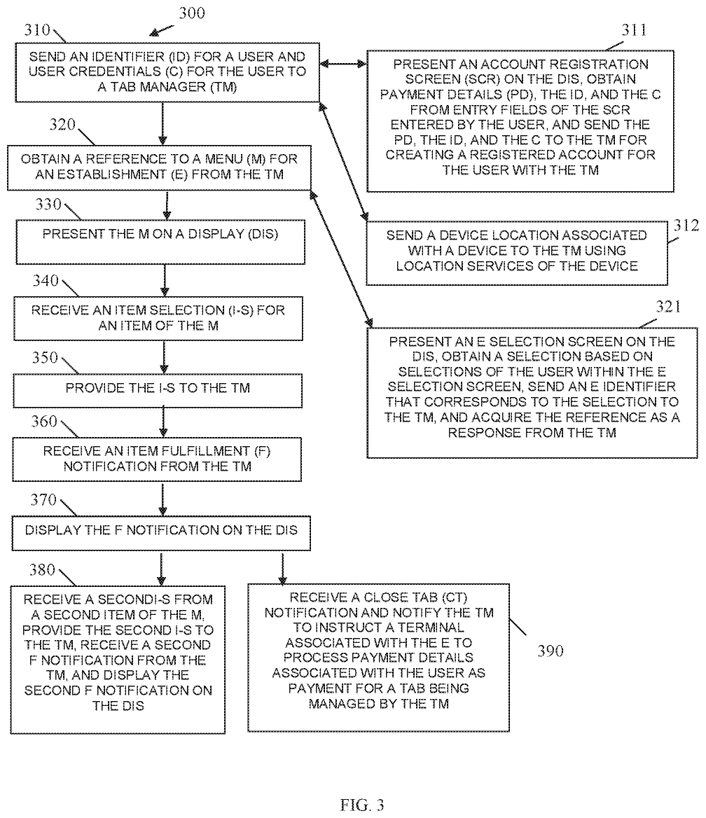

FIG. 3 is a diagram of another method for mobile order processing, according to an example embodiment, according to an example embodiment. The software module(s) that implements the method 300 is referred to as an “order mobile application.” The order mobile application is implemented as executable instructions programmed and residing within memory and/or a non-transitory computer-readable (processor-readable) storage medium and executed by one or more hardware processors of a hardware device. The processors of the device that executes the order mobile application are specifically configured and programmed to process the order mobile application. The order mobile application has access to one or more networks during its processing. The networks can be wired, wireless, or a combination of wired and wireless.

The device that execute the order mobile application is user-operated mobile device 120. In an embodiment, mobile device 120 is a phone, a tablet, a laptop, and a wearable processing device,

In an embodiment, the order mobile application is mobile application 121.

In an embodiment, the order mobile application interacts with method 200 to perform mobile order processing.

At 310, the order mobile application sends an identifier for a user and user credentials for the user to a tab manager. In an embodiment, the tab manager is all of or some combination of tab manager 111 and/or the method 200.

In an embodiment, at 311, the order mobile application presents an account registration screen on a display of the device that executes the order mobile application. The order mobile application obtains payment details, the identifier, and the credentials from entry fields of the account registration screen. The order mobile application sends the payment details, the identifier, and the credentials to the tab manager for creating a registered account for the user with the tab manager.

In an embodiment, at 312, the order mobile application sends a device location associated with the device to the tab manager using location services of the device. The device executes the tab manager.

At 320, the order mobile application obtains a reference to a menu for an establishment from the tab manager.

In an embodiment, at 321, the order mobile application presents an establishment selection screen on the display of the device that executes the order mobile application. The order mobile application obtains a selection based on selections of the user within the establishment selection screen and sends an establishment identifier that corresponds to the selection to the tab manager. The order mobile application then acquires the references to the menu as a response received back from the tab manager (responsive to the order mobile application providing the establishment identifier selected by the user through the establishment selection screen).

At 330, the order mobile application presents the menu (obtained from the reference) on the display of the device that executes the order mobile application.

At 340, the order mobile application receives an item selection for an item of the menu based on user selection from the menu.

At 350, the order mobile application provides the item-selection to the tab manager.

At 360, the order mobile application receives an item fulfillment notification back from the tab manager.

At 370, the order mobile application displays the item fulfillment notification on the display to the user.

In an embodiment, at 380, the order mobile application receives a second item selection for a second item of the menu and provides the second item selection to the tab manager. The order mobile application receives a second item fulfillment notification from the tab manager and displays the second item fulfillment notification on the display.

In an embodiment, at 390, the order mobile application receives a close tab notification selected by the user from the display. The order mobile application notifies the tab manager. The tab manager instructs a terminal associated with the establishment to process payment details associated with the user as payment for a tab being managed by the tab manager.

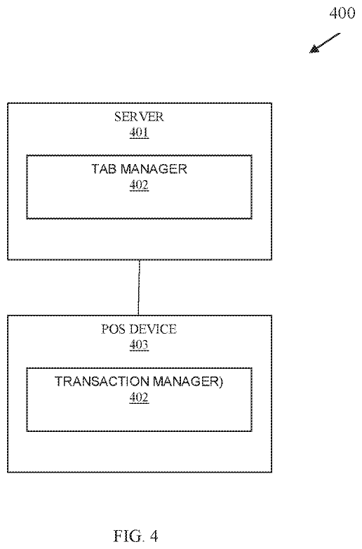

FIG. 4 is a diagram of another system 400 for mobile order processing, according to an example embodiment. The system 400 includes a variety of hardware components and software components. The software components of the system 400 are programmed and reside within memory and/or a non-transitory computer-readable medium and execute on one or more hardware processors of a hardware device. The system 400 communicates one or more networks, which can be wired, wireless, or a combination of wired and wireless.

In an embodiment, the system 400 implements all or some combination of the processing discussed above with the FIGS. 1A, 1B, 2, and 3.

In an embodiment, the system 400 implements, inter olio; the method 200 of the FIG. 2.

The system 400 includes a server 401 and a POS terminal 403. The server 401 includes a processor and non-transitory computer-readable storage media having executable instructions representing tab manager 402. The POS terminal 403 includes a processor and non-transitory computer-readable storage media having executable instructions representing transaction manager 404.

The tab manager 402 when executed by the processor of the server 401 from the non-transitory computer-readable storage medium causes the processor to perform processing comprising: 1) identifying a user account for a user when a mobile application is initiated on a mobile device operated by the user; 2) obtaining a device location for the device from the mobile application; 3) obtaining a menu associated with an establishment that correlates with the device location; 4) receiving an item selection for an item of the menu from the mobile application; 5) opening a tab for the user; 6) forwarding the item selection and payment details registered to the user account to the transaction manager 404 of the POS terminal 403; 6) receiving an item fulfillment notification from the transaction manager 404; 7) sending the item fulfillment notification to the mobile application; 8) receiving a close tab selection from the mobile application; and 9) instructing the transaction manager 403 to close the tab and obtain a payment by processing the payment details.

In an embodiment, the tab manager 402 is all of or some combination of tab manager 111 and/or method 200.

The transaction manager 404 when executed by the processor of POS terminal 403 from a non-transitory computer-readable storage medium causes the processor to perform processing comprising: 1) obtaining the item selection and payment details from the tab manager 402; 2) displaying item details on a display associated with the POS terminal 403; 3) receiving the item fulfillment notification from a selection made on a fulfillment screen presented on the display; 4) sending the item fulfillment notification to the tab manager 402; 5) receiving an instruction from the tab manager 402 to close the tab; and 6) processing the payment details as the payment for the tab.

In an embodiment transaction manager 404 is transaction manager 131.

In an embodiment, the mobile device is a phone, a tablet, or a wearable processing device; the server 401 is part of a cloud processing environment; and the POS 403 terminal is located within the establishment.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
providing executable instructions to a hardware processor of a server from a non-transitory computer-readable storage medium causing the hardware processor to perform operations comprising:
receiving an identifier and a device location from a mobile application executing on a device that is being operated by a user when the user logs into the mobile application on the device;
associating the identifier with a registered account;
identifying an establishment associated with the device location;
passing a reference link to a menu of the establishment to the mobile application;
obtaining an item selection for an item of the menu from the mobile application;
opening a tab for the item; and
forwarding the item selection and payment details associated with the registered account to a terminal associated with the establishment.

2. The method of claim 1 further comprising:
receiving a second item selection for a second item of the menu from the mobile application; and
forwarding the second item selection to the terminal.

3. The method of claim 2 further comprising:
receiving a close tab selection from the mobile application;
forwarding an indication to the terminal to process payment with the payment details for the tab.

4. The method of claim 1, wherein receiving further includes registering the identifier and the user to the registered account.

5. The method of claim 1, wherein associating further includes authenticating credentials associated with the registered account provided by the mobile application.

6. The method of claim 1, wherein forwarding further includes receiving an item fulfillment notification from the terminal and pushing an item pick-up notification to the mobile application.

7. The method of claim 1, wherein forwarding further includes receiving a close tab selection from the mobile application, notifying the terminal to process the payment details, and sending tab details associated with the tab to the mobile application.

8. The method of claim 7, wherein receiving the close tab selection further includes sending a promotion to the mobile application and storing the promotion in the registered account.

9. The method of claim 8 further comprising:
receiving a promotion redemption option from the mobile application during processing of a second tab associated with a different establishment;
obtaining the promotion from the registered account using the promotion redemption option; and
sending an indication with the payment details provided to a different terminal associated with the second tab to apply promotion details associated with the promotion to second tab details when processing the payment details as payment for the second tab.

10. The method of claim 7 further comprising, sending an option to obtain a promotion with a permission to post a social media message about the user and the item that was ordered at the establishment.

11. The method of claim 10, wherein sending further includes receiving a confirmation for the option from the mobile application, posting the social media message to a social media account, and storing the promotion in the registered account.

12. The method of claim 1, wherein forwarding further includes receiving real-time updates for the item from the terminal and sending the real-time updates as in-application push messages to the mobile application.

13. A method, comprising:
providing executable instructions to a hardware processor of a mobile device from a non-transitory computer-readable storage medium causing the hardware processor to perform operations comprising:
sending an identifier for a user and user credentials for the user to a tab manager;
reporting a device location of the mobile device obtained from location services of the mobile device and reported to the tab manager after the tab manager authenticates the user with the user credentials;
obtaining a reference to a menu for an establishment from the tab manager, wherein the establishment identified by the tab manager from the device location;
presenting the menu on a display;
receiving an item selection for an item of the menu;
providing the item selection to the tab manager;
receiving an item fulfillment notification from the tab manager; and
displaying the item fulfillment notification on the display.

14. The method of claim 13 further comprising, receiving a second item selection from a second item of the menu, providing the second item selection to the tab manager, receiving a second item fulfillment notification from the tab manager, and display the second item fulfillment notification on the display.

15. The method of claim 13 further comprising, receiving a close tab notification and notifying the tab manager to instruct a terminal associated with the establishment to process payment details associated with the user as payment for a tab being managed by the tab manager.

16. The method of claim 13, wherein sending further includes presenting an account registration screen on the display, obtaining payment details, the identifier, and the credentials from entry fields of the account registration screen entered by the user, and sending the payment details, the identifier, and the credentials to the tab manager for creating a registered account for the user with the tab manager.

17. (canceled)

18. The method of claim 13, wherein obtaining further includes presenting an establishment selection screen on the display, obtaining a selection based on selections of the user within the establishment selection screen, sending an establishment identifier that corresponds to the selection to the tab manager, and acquiring the reference as a response from the tab manager.

19. A system (SST), comprising:
a server comprising a server processor and a server non-transitory computer-readable storage medium that comprises executable instructions representing a tab manager;
a Point-Of-Sale (POS) terminal comprising a terminal processor and a terminal non-transitory computer-readable storage medium that comprises executable instructions represent a transaction manager;
the tab manager when executed by the server processor from the server non-transitory computer-readable storage medium causes the server processor to perform first operations comprising:
identifying a user account for a user when a mobile application is initiated on a mobile device operated by the user and the user logs into the mobile application;
obtaining a device location for the device from the mobile application;
identifying an establishment based on the device location;
obtaining a menu for the establishment;
receiving an item selection for an item of the menu from the mobile application;
opening a tab for the user;
forwarding the item selection and payment details registered to the user account to the transaction manager of the POS terminal;
receiving an item fulfillment notification from the transaction manager;
sending the item fulfillment notification to the mobile application;
receiving a close tab selection from the mobile application; and
instructing the transaction manager to close the tab and obtain a payment by processing the payment details;
the transaction manager when executed by the terminal processor from the terminal non-transitory computer-readable storage medium causes the terminal processor to perform second operations comprising:
forwarding credentials supplied by the user to the tab manager;
obtaining the device location from location services of the mobile device;
forwarding the device location to the tab manager;
obtaining the item selection and payment details from the tab manager;
displaying item details on a display associated with the POS terminal;
receiving the item fulfillment notification from a selection made on a fulfillment screen presented on the display;
sending the item fulfillment notification to the tab manager;
receiving an instruction from the tab manager to close the tab; and
processing the payment details as the payment for the tab.

20. The system of claim 19, wherein mobile device is a phone, a tablet, or a wearable processing device, and wherein the server is associated with a cloud processing environment, and wherein the POS terminal is located within the establishment.
